(19) United States
(12) Patent Application Publication
(10) Pub. No.: US 2026/0100971 A1
(43) Pub. Date: Apr. 9, 2026

(54) AUTOMATED SECURE SOCKETS LAYER CERTIFICATE DISCOVERY AND MANAGEMENT

(71) Applicant: BANK OF AMERICA CORPORATION, Charlotte, NC (US)

(72) Inventors: John David Weber, Lake Saint Louis, MO (US); Steve Baylon, Virginia Beach, VA (US); Paul Huddy, Farmington Hills, MI (US); Rakesh Jain, Murphy, TX (US); Don L. Maxwell, Bedford, TX (US); Pramod Muppala, Concord, NC (US); Ajesh Philip, Hyderabad (IN); Nancy D. Royall, Prosper, TX (US); Jonathan Shilling, Ponte Vedra, FL (US)

(73) Assignee: BANK OF AMERICA CORPORATION, Charlotte, NC (US)

(21) Appl. No.: 18/908,296

(22) Filed: Oct. 7, 2024

(51) Int. Cl. H04L 9/40

(52) U.S. Cl. CPC H04L 63/166; H04L 63/108; H04L 63/20

(57) ABSTRACT

Systems, computer program products, and methods are described herein for automated secure transport protocol (STP) certificate discovery and management. The present disclosure is configured to generate a list of servers to be scanned for STP certificates. A trust store file within each server in the list of servers is periodically scanned, wherein the scan is configured to identify (i) one or more STP certificates and an associated expiration date for each of the one or more STP certificates and (ii) additional STP certificates that have been added to the filesystem. A frequency of the scan of each trust store file is determined based on a proximity to the associated expiration date of at least one of the one or more STP certificates. The list of servers is updated to include the identified one or more STP certificates and the associated expiration date of the one or more STP certificates.

### TECHNOLOGICAL FIELD

Example embodiments of the present disclosure relate to automated secure transport protocol certificate, discovery and management.

### BACKGROUND

Secure transport protocol certificates (referred to herein as STP certificates), such as Secure Sockets Layer (SSL) or Transport Layer Security (TLS) certificates or are implemented to secure websites and/or applications. In some instances, these STP certificates are installed on hundreds of thousands of servers. Traditional systems require manual input which presents a challenge to the discovery and management of these certificates.

Currently there are deficiencies and problems associated with automated STP certificate discovery and management. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later. The present invention provides for a system, method, and computer program product for automated secure transport protocol certificate (i.e., STP certificate) discovery and management. Secure transfer protocol certificates may include, but are not limited to, Secure Sockets Layer (SSL) certificates, Transport Layer Security (TLS) certificates and the like. The system comprising a memory device with computer-readable program code stored thereon and a processing device operatively coupled to the memory device, wherein the processing device is configured to execute the computer-readable program code to generate a list of servers to be scanned for STP certificates, wherein the list of servers to be scanned for STP certificates comprises one or more servers with a filesystem. The system scans a trust store file of one or more trust stores within each server in the list of servers, wherein the scan is configured to identify (i) one or more STP certificates and an associated expiration date for each of the one or more STP certificates and (ii) additional STP certificates that have been added to the filesystem. The system determines a frequency of the scan of the trust store file of the one or more trust stores based on a proximity to the associated expiration date of at least one of the one or more STP certificates, wherein the frequency of the scan increases closer to the associated expiration date of the at least one STP certificate. The system updates the list of servers to include the identified one or more STP certificates and the associated expiration date of the one or more STP certificates.

Executing the instructions further causes the processing device to execute the computer-readable program code to scan the STP certificate of the one or more servers. Based on the scan of the certificate, the system identifies one or more servers named on a subject alternative name list, wherein the subject alternative name list comprises a list of servers with unique names having a same STP certificate in use. The system determines that the STP certificate is located within each server identified on the subject alternative name list. The system determines that all servers with the STP certificate in use are listed on the subject alternative name list.

Prior to scanning the one or more trust stores, the system implements a checksum to verify that the trust store has not changed since a last-in-time scan, and in response to verifying that the trust store has not changed, the system foregoes the scan of the trust store.

Scanning further comprises (i) comparing the plurality of STP certificates stored in the trust store to determine the existence of a renewed certificate associated with a first Universal Resource Locator (URL) and an expired certificate associated with the first URL, and (ii) in response to determining the existence of the renewed certificate and the expired certificate, automatically removing the expired certificate from the trust store.

In some embodiments, the one or more trust files of the one or more trust stores are scanned. In some other embodiments, one or more keystore files of one or more keystores are scanned. In some further embodiments, one or more standalone STP certificates are scanned.

STP certificates are automatically renewed based on the associated expiration date of the STP certificate and wherein the renewed one or more STP certificates are automatically copied to the server which has the STP certificate in use.

The server restarts to activate the renewed one or more STP certificates and wherein the restart is scheduled based on a manually selected time frame.

The present invention further provides for a computer program product for automated STP certificate discovery and management, the computer program product comprising a non-transitory computer-readable medium comprising code causing an apparatus to generate a list of servers to be scanned for STP certificates, wherein the list of servers to scanned for STP certificates comprises one or more servers with a filesystem. The computer program product scans a trust store file of the one or more trust stores within each server in the list of servers, wherein the scan is configured to identify (i) one or more STP certificates and an associated expiration date for each of the one or more STP certificates and (ii) additional STP certificates that have been added to the filesystem. The computer program product determines a frequency of the scan of the trust store file of the one or more trust stores based on a proximity of the associated expiration date of at least one of the one or more STP certificates, wherein the frequency of the scan increases closer to the associated expiration date of the at least one STP certificate. The computer program product updates the list of servers to include the identified one or more STP certificates and the associated expiration date of the one or more STP certificates.

The present invention further provides for a method for automated STP discovery and management, the method comprising generating a list of servers to be scanned for STP certificates, wherein the list of servers to be scanned for STP certificates comprises one or more servers with a filesystem. The method scans a trust store file of the one or more trust stores within each server in the list of servers, wherein the scan is configured to identify (i) one or more STP certificates and an associated expiration date for each of the one or more STP certificates and (ii) additional STP certificates that have been added to the filesystem. The method determines a frequency of the scan of the trust store file of the one or more trust stores based on a proximity to the associated expiration date of at least one of the one or more STP certificates, wherein the frequency of the scan increases closer to the associated expiration date of the at least one STP certificate. The method updates the list of servers to include the identified one or more STP certificates and the associated expiration date of the one or more STP certificates.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automated secure transport protocol (STP) certificate discovery and management, in accordance with an embodiment of the disclosure.

FIG. 2 illustrates a process flow for automated STP certificate discovery and management, in accordance with an embodiment of the disclosure.

FIG. 3 illustrates a process flow for identifying a list of servers on a subject alternative name list, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

The present invention automates the process for discovery and management of secure transport protocol certificates (referred to herein as STP certificates), which may include, but are not limited to, Secure Sockets Layer (SSL) certificates, Transport Layer Security (TLS) certificates and the like. A list of servers is generated automatically and scanned for STP certificates. Each server on the list of servers is scanned periodically to identify STP certificates and expiration dates associated with each STP certificate. The scan also identifies any STP certificates that have been added to the server. The frequency of the scan of each server depends on the proximity to the expiration date of the at least one STP certificate.

Current systems for the discovery and management of STP certificates require manual inputs which presents a challenge given the large number of servers an entity may own.

Accordingly, the present disclosure generates a list of servers to be scanned for STP certificates. Each server in the list of servers comprises at least one filesystem. A trust store file of one or more trust stores within each server in the list of servers is scanned. The scan is configured to identify one or more STP certificates and the expiration dates associated with each STP certificate. The scan also identifies if any STP certificates have been added to the filesystem. The list of servers is updated to include the STP certificates and the associated expiration dates. The scan of the one or more trust store files occurs at a frequency based on the proximity to the expiration date of at least one of the one or more STP certificates.

Furthermore, the present disclosure provides a technical solution to a technical problem. As described herein, the technical problem includes the challenge of manually discovering and managing expiring STP certificates. The technical solution presented herein allows for the automated discovery and management of STP certificates which obviates the need for manual input and improves the efficiency of the system. In particular, an automated system for the discovery and management of STP certificates is an improvement over existing solutions to manage the expiration and renewal of hundreds of thousands of STP certificates, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

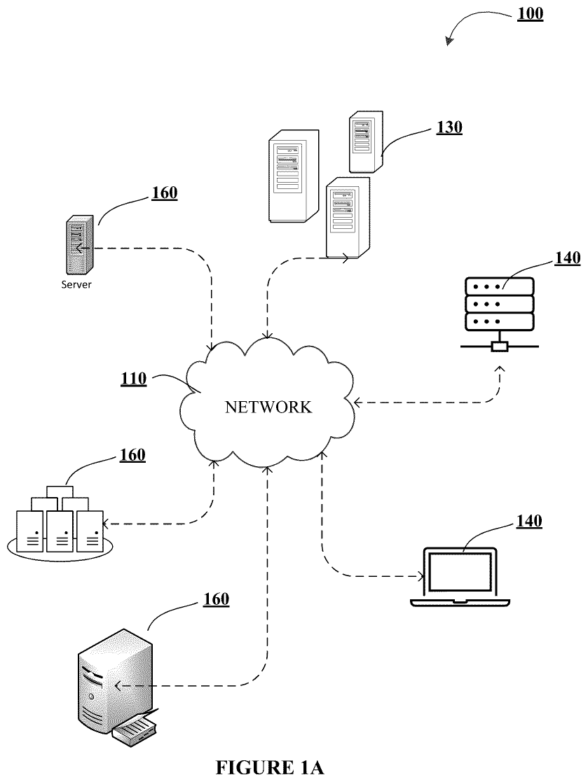

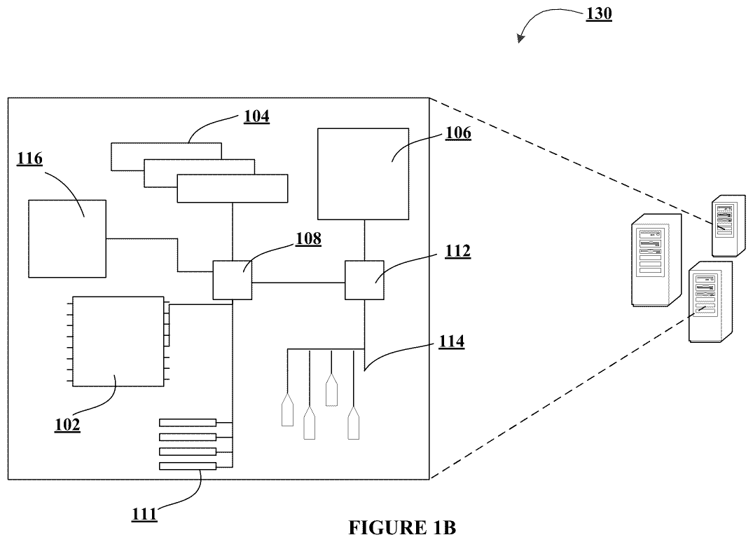

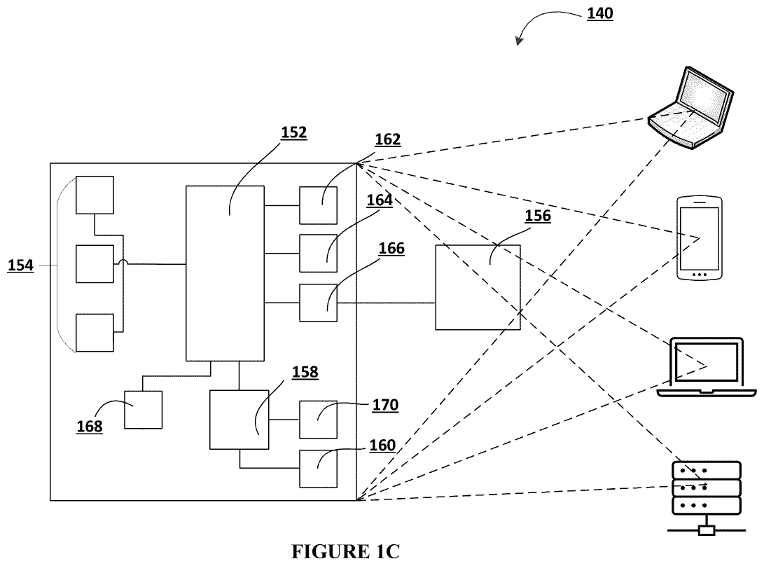

FIGS. 1A-1C illustrate technical components of an exemplary distributed computing environment for automated STP certificate discovery and management 100, in accordance with an embodiment of the disclosure. As previously discussed, STP certificates, may include, but are not limited to, Secure Sockets Layer (SSL) certificates, Transport Layer Security (TLS) certificates and the like. As shown in FIG. 1A, the distributed computing environment 100 contemplated herein may include a system 130, an end-point device(s) 140, server(s) 160, and a network 110 over which the system 130, server(s) 160, and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the end-point device(s) 140 may be electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like. In one aspect, the end-point device(s) 140 may interact with the system 130 to retrieve STP certificate details, monitor certificate statuses, and respond to alerts related to certificate expirations or additions. In another aspect, the end-point device(s) 140 may access the websites and services hosted by the server(s) 160 over the network 110, utilizing the STP certificates managed by the system 130 to establish secure connections. When an endpoint device 140 initiates a connection to a server-hosted website, the STP certificate associated with that server 160 is validated, ensuring that the data exchanged between the server 160 and the end-point device 140 is encrypted and secure.

In some embodiments, the system 130 may execute the automated processes for discovering and managing STP certificates. The system 130 may perform periodic scans of the server(s) (e.g., server(s) 160), monitor their expiration dates, and identify newly added certificates. In specific embodiments, the scanning frequency of the system 130 may be adjusted based on the proximity of the STP certificate's expiration date, increasing as the expiration date nears. The system 130 may represent various forms of servers, such as web servers, database servers, file servers, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

In some embodiments, the server(s) 160 may represent the sources of STP certificates within the infrastructure (e.g., the system environment 100). As described herein, embodiments of the invention automatically generate a list of these servers and performs periodic scans to identify STP certificates and their associated expiration dates. In this regard, each server 160 may include a filesystem with one or more trust and/or keystores. These trust and/or keystores may include a plurality of STP certificates in one file within the filesystem. The one or more trust and/or keystores of each server are scanned by a scanning device to identify STP certificates and the associated expiration dates of the one or more STP certificates. The expiring STP certificates are removed, and the STP certificate is renewed through a renewal process. The renewal process for each STP certificate prevents the disruption of use of a website and/or application by a user of an end-point device 140. The server(s) 160 depicted in the network environment are diverse in type and configuration, encompassing a wide range of server hardware utilized by institutions. The server(s) 160 may include, but are not limited to, web servers that host websites and online services, application servers that run specific applications or provide backend functionalities, database servers that store and manage data, email servers, and other specialized servers integral to the institution's IT infrastructure. Each server, regardless of its specific function, is a potential source of STP certificates that require continuous monitoring and management.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

The interactions between the server(s) 160, the system 130, and the end-point device(s) 140 via the network 110 may be characterized by various types of relationships, including client-server and peer-to-peer configurations, depending on the specific context of communication and task execution.

For instance, the relationship between the server(s) 160 and the system 130 may primarily be a client-server configuration. In this setup, the system 130 may act as the client, initiating communication with the server(s) 160 to perform scans for STP certificates. The server(s) 160 may function as service providers, responding to the system's 130 requests for certificate data, including certificate details and expiration dates. The system 130 may periodically query the server(s) 160, retrieve STP information, and update its internal records accordingly. Such a client-server dynamic allows the system 130 to manage multiple servers 160, centralizing STP certificate management across the network while continuously monitoring for changes.

Similarly, the interaction between server(s) 160 and end-point device(s) 140 operates primarily as a client-server relationship, where the end-point device(s) 140 act as clients seeking to access websites and/or services hosted by the server(s) 160. When an endpoint device 140 connects to a server-hosted application, the server 160 provides the requested service, validating STP certificates as part of the secure connection establishment process. In this context, the server(s) 160 may be responsible for delivering secure content and maintaining the trustworthiness of communications through the STP certificates managed by the system 130. Additionally, end-point device(s) 140 may rely on this secure client-server interaction for day-to-day operations, such as accessing databases, web applications, or other online resources hosted on the server(s) 160.

The relationship between the system 130 and end-point device(s) 140 can vary between a client-server and a peer-to-peer interaction, depending on the nature of the communication. In a client-server model, the end-point device(s) 140 may function as clients that access the system's 130 interface or management console to review STP certificate statuses, receive expiration alerts, or configure scanning parameters. The system 130 may serve as the central authority, processing requests from the endpoint devices and providing the necessary information for STP certificate management. In some scenarios, especially those involving administrative or monitoring functions, this interaction may also resemble a peer-to-peer relationship, where end-point device(s) 140 and the system 130 collaborate directly to share information and manage STP certificates. For instance, administrative end-point device(s) 140 could communicate bidirectionally with the system 130 to adjust scanning schedules based on operational needs or respond to security alerts.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

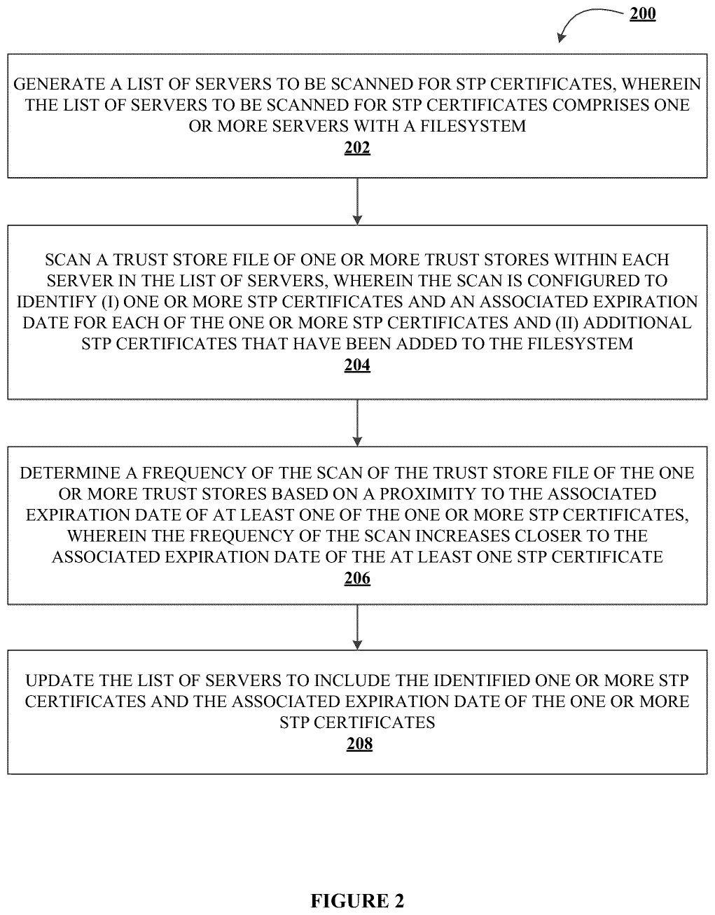

FIG. 2 illustrates a flow diagram of a method 200 for the automated discovery and management of STP certificates. At Event 202, a list of servers to be scanned for STP certificates is generated, wherein the list of servers to be scanned for STP certificates comprises one or more servers with a filesystem. In some embodiments, the list of servers is generated from downstream data in real time. In some other embodiments, the one or more servers comprise one or more STP certificates within the filesystem of the server, wherein an STP certificate secures a website and/or application. For example, the one or more STP certificates may encrypt a website associated with an entity, wherein users may check one or more resource accounts and/or make resource transfers. In some embodiments, STP certificates include, but are not limited to, secure sockets layer (SSL) and transport layer security (TLS) certificates, and the like. In another example, a first server comprises a first certificate, and a second server comprises a plurality of certificates. In some other embodiments, servers are added and/or removed from the list of servers. For example, one or more servers are automatically added to the list of servers as the servers are built. One or more servers that have been decommissioned are automatically removed from the list of servers. A decommissioned server is one in which the server is no longer in use as part of the routine lifecycle of servers. In some embodiments, a script file manages the addition and/or removal of servers from the list of servers.

At Event 204, a trust store file of the one or more trust stores within each server in the list of servers is scanned, wherein the scan is configured to identify (i) one or more STP certificates and an associated expiration date for each of the one or more STP certificates and (ii) additional STP certificates that have been added to the filesystem. In some embodiments, a script file manages which servers are to be scanned. In some other embodiments, a trust store and/or keystore is installed on one or more servers in the list of servers, wherein the trust store and/or keystore allow multiple STP certificates to be stored within a single file on the server, including SSL and TLS certificates and the like. In some embodiments, more than one trust store and/or keystore is installed on the server. In some other embodiments, the trust store and/or keystore comprise one or more trust and/or keystore files which may be referenced as certificate authority certificates (cacerts) files, which are a repository for the one or more STP certificates. In some further embodiments, the scan comprises a scan of a keystore file within one or more keystores as well as a scan of one or more STP certificates that standalone and which are not within a trust store and/or keystore. The expiration date of an STP certificate is the date that the STP certificate will no longer encrypt and/or secure the website and/or application. In some other embodiments, a scan of the trust store and/or keystore file is performed to identify the expiration dates of the one or more STP certificates within the file. Each trust store and/or keystore file within the one or more servers is scanned such that all STP certificates within the filesystem of the one or more servers are identified along with each associated expiration date. In some other embodiments, only some portion of the plurality of trust stores and/or keystores, and not all of the trust stores and/or keystores, are scanned at a given time. In this embodiment, prior to a scan of the trust store and/or keystore file, the system uses a checksum to verify that the trust store hasn't changed since the last-in-time scan. If the trust store hasn't changed, the system forgoes the scan of the trust store. In some embodiments, scanning further comprises (i) comparing the plurality of STP certificates stored in the trust store to determine the existence of a renewed certificate associated with the first Universal Resource Locator (URL) and an expired certificate associated with the first URL and (ii) automatically removing the expired certificate from the trust store, in response to determining the existence of the renewed certificate and the expired certificate.

At Event 206, a frequency of the scan of the trust store file of the one or more trust stores is determined based on a proximity to the associated expiration date of at least one of the one or more STP certificates. In some embodiments, the frequency of the scan increases closer to the associated expiration date of the at least one STP certificate. In one example, the present date is nearing the expiration date of a first STP certificate, and the scan of the server occurs more frequently as the expiration date of the first STP certificate nears. In some other embodiments, the frequency of the scan is specified by an institution in accordance with the policy of that institution. In some embodiments, one or more STP certificates have a different expiration date. For example, a first STP certificate has an expiration date that is closer to the present date than the expiration date of a second STP certificate. In some other embodiments, a first STP certificate has an expiration date that is further from the current date than a second STP certificate. In still other embodiments, two or more STP certificates have the same expiration date. At Event 208, the list of servers is updated to include the identified one or more STP certificates and the associated expiration date of the one or more STP certificates. The list of servers is automatically updated, wherein no manual input is performed to update the list of servers. In some embodiments, the list of servers is updated on a daily basis. In some other embodiments, the list of servers is updated on a weekly or monthly basis and the like.

In some embodiments, each STP certificate is automatically renewed. The process of renewal of the STP certificate occurs within a defined period before the STP certificate has expired. For example, the process of renewal of an STP certificate is automatically started days, weeks, and the like before the expiration date of the STP certificate. In some embodiments, the STP certificate may be renewed the day of the expiration date. The STP certificate is renewed in such a way that there is no disruption to the use of the website and/or application the STP certificate secures. First, a request is made to the Certificate Management software via an Application Programming Interface (API). The one or more renewed STP certificates are then automatically copied to the server which has the STP certificate in use. The server then restarts to activate the renewed STP certificates. The restart is automatically scheduled based on a chosen time frame.

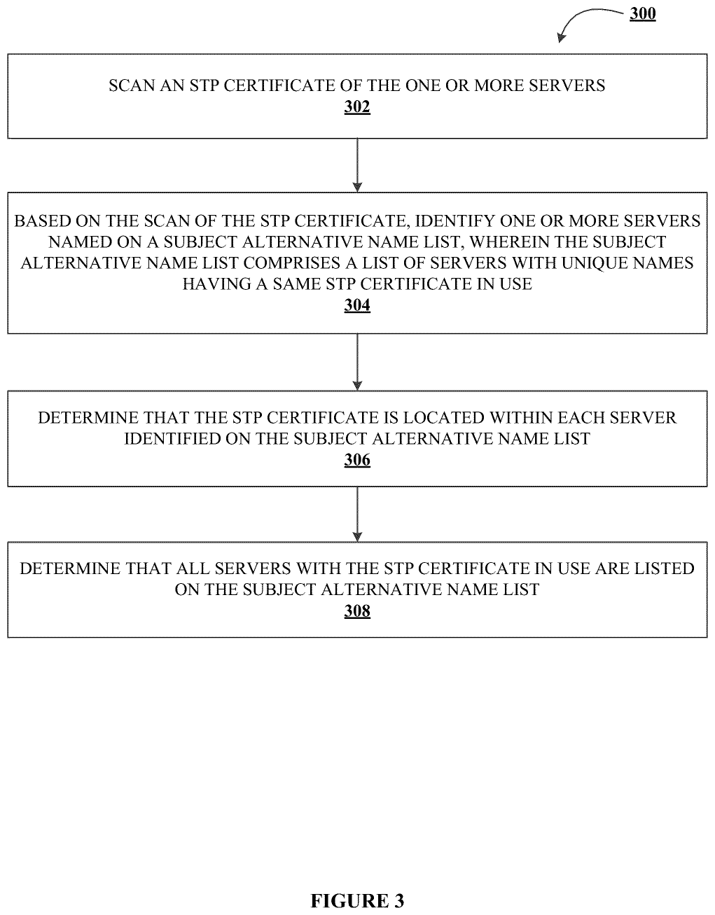

FIG. 3 illustrates a flow diagram of a method 300 for the identification of one or more servers on a Subject Alternative Name (SAN) list. At Event 302, an STP certificate of the one or more servers is scanned, including SSL and TLS certificates and the like. In some embodiments, one or more STP certificates are scanned at the same time. In some other embodiments, the scan of the STP certificate occurs automatically. At Event 304, based on the scan of the STP certificate, one or more servers named on a SAN list are identified, wherein the SAN list comprises a list of servers with unique names having a same STP certificate in use. For example, a first server is named server one, a second server is named server two, a third server is named server three, and the like. The same STP certificate, with the name of the website and/or application it encrypts, is found on each of the first, second, and third servers in the SAN list. In other embodiments, one certificate may secure a plurality of servers.

At Event 306, it is determined that the STP certificate is located within each server identified on the SAN list. In some embodiments, an error message is produced when a server is named on the SAN list but does not have the STP certificate in use. For example, an STP certificate is located within a server one, server two, and server three. In some embodiments, the STP certificate includes SSL and TLS certificates and the like. Servers one, two, three, and four are named on the SAN list but server four does not have the STP certificate in use. At Event 308, the system determines that all servers with the STP certificate in use are listed on the SAN list. For example, servers one, two, and three are named on the SAN list, and server four, which also comprises the same STP certificate as servers one, two, and three, is not named on the SAN list.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#. It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s). The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention. While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automated secure transport protocol (STP) certificate discovery and management, the system comprising:
a non-transitory storage device with computer-readable program code stored thereon; and
a processing device coupled to the non-transitory device, wherein the processing device is configured to execute the computer-readable program code to:
generate a list of servers to be scanned for secure transport protocol certificates, wherein the list of servers to be scanned for STP certificates comprises one or more servers with a filesystem;
scan a trust store file of one or more trust stores within each server in the list of servers, wherein the scan is configured to identify (i) one or more STP certificates and an associated expiration date for each of the one or more STP certificates and (ii) additional STP certificates that have been added to the filesystem;
determine a frequency of the scan of the trust store file of the one or more trust stores based on a proximity to the associated expiration date of at least one of the one or more STP certificates, wherein the frequency of the scan increases closer to the associated expiration date of the at least one STP certificate; and
update the list of servers to include the identified one or more STP certificates and the associated expiration date of the one or more STP certificates.

2. The system of claim 1, wherein executing the instructions further causes the processing device to execute the computer-readable program code to:
scan the STP certificate of the one or more servers;
based on the scan of the STP certificate, identify one or more servers named on a subject alternative name list, wherein the subject alternative name list comprises a list of servers with unique names having a same STP certificate in use;
determine that the STP certificate is located within each server identified on the subject alternative name list; and
determine that all servers with the STP certificate in use are listed on the subject alternative name list.

3. The system of claim 1, wherein prior to scanning the one or more trust stores, the system implements a checksum to verify that the trust store has not changed since a last-in-time scan, and in response to verifying that the trust store has not changed, the system foregoes the scan of the trust store.

4. The system of claim 1, wherein scanning further comprises (i) comparing the plurality of STP certificates stored in the trust store to determine the existence of a renewed certificate associated with a first Universal Resource Locator (URL) and an expired certificate associated with the first URL, and (ii) in response to determining the existence of the renewed certificate and the expired certificate, automatically removing the expired certificate from the trust store.

5. The system of claim 1, wherein the scan further comprises a scan of a keystore file of one or more keystores and of one or more STP certificates not within the trust store and/or keystore.

6. The system of claim 1, wherein STP certificates are automatically renewed based on the associated expiration date of the STP certificate and wherein the renewed one or more STP certificates are automatically copied to the server which has the STP certificate in use.

7. The system of claim 6, wherein the server restarts to activate the renewed one or more STP certificates, and wherein the restart is scheduled based on a manually selected time frame.

8. A computer program product for automated secure transport protocol (STP) certificate discovery and management, the computer program product comprising a non-transitory computer-readable medium comprising code causing an apparatus to:
generate a list of servers to be scanned for STP certificates, wherein the list of servers to be scanned for STP certificates comprises one or more servers with a filesystem;
scan a trust store file of one or more trust stores within each server in the list of servers, wherein the scan is configured to identify (i) one or more STP certificates and an associated expiration date for each of the one or more STP certificates and (ii) additional STP certificates that have been added to the filesystem;
determine a frequency of the scan of the trust store file of the one or more trust stores based on a proximity to the associated expiration date of at least one of the one or more STP certificates, wherein the frequency of the scan increases closer to the associated expiration date of the at least one STP certificate; and
update the list of servers to include the identified one or more STP certificates and the associated expiration date of the one or more STP certificates.

9. The computer program product of claim 8, wherein the code further causes the apparatus to:
scan the STP certificate of the one or more servers;
based on the scan of the certificate, identify one or more servers named on a subject alternative name list, wherein the subject alternative name list comprises a list of servers with unique names having a same STP certificate in use;
determine that the STP certificate is located within each server identified on the subject alternative name list; and
determine that all servers with the STP certificate in use are listed on the subject alternative name list.

10. The computer program product of claim 8, wherein prior to scanning the one or more trust stores, the system implements a checksum to verify that the trust store has not changed since a last-in-time scan, and in response to verifying that the trust store has not changed, the system foregoes the scan of the trust store.

11. The computer program product of claim 8, wherein scanning further comprises (i) comparing the plurality of STP certificates stored in the trust store to determine the existence of a renewed certificate associated with a first Universal Resource Locator (URL) and an expired certificate associated with the first URL, and (ii) in response to determining the existence of the renewed certificate and the expired certificate, automatically removing the expired certificate from the trust store.

12. The system of claim 8, wherein the scan further comprises a scan of a keystore file of one or more keystores and of one or more STP certificates not within a trust store and/or keystore.

13. The computer program product of claim 8, wherein STP certificates are automatically renewed based on the associated expiration date of the STP certificate and wherein the renewed one or more STP certificates are automatically copied to the server which has the STP certificate in use.

14. The computer program product of claim 13, wherein the server restarts to activate the renewed one or more STP certificates, and wherein the restart is scheduled based on a manually selected time frame.

15. A method for automated secure transport protocol (STP) certificate discovery and management, the method comprising:
generating a list of servers to be scanned for STP certificates, wherein the list of servers to be scanned for STP certificates comprises one or more servers with a filesystem;
scanning a trust store file of one or more trust stores within each server in the list of servers, wherein the scan is configured to identify (i) one or more STP certificates and an associated expiration date for each of the one or more STP certificates and (ii) additional STP certificates that have been added to the filesystem;
determining a frequency of the scan of the trust store file of the one or more trust stores based on a proximity to the associated expiration date of at least one of the one or more STP certificates, wherein the frequency of the scan increases closer to the associated expiration date of the at least one STP certificate; and
updating the list of servers to include the identified one or more STP certificates and the associated expiration date of the one or more STP certificates.

16. The method of claim 15, wherein the method further comprises:
scanning the STP certificate of the one or more servers;
based on the scan of the certificate, identifying one or more servers named on a subject alternative name list, wherein the subject alternative name list comprises a list of servers with unique names having a same STP certificate in use;
determining that the STP certificate is located within each server identified on the subject alternative name list; and
determining that all servers with the STP certificate in use are listed on the subject alternative name list.

17. The method of claim 15, wherein prior to scanning the one or more trust stores, the system implements a checksum to verify that the trust store has not changed since a last-in-time scan, and in response to verifying that the trust store has not changed, the system foregoes the scan of the trust store.

18. The method of claim 15, wherein scanning further comprises (i) comparing the plurality of STP certificates stored in the trust store to determine the existence of a renewed certificate associated with a first Universal Resource Locator (URL) and an expired certificate associated with the first URL, and (ii) in response to determining the existence of the renewed certificate and the expired certificate, automatically removing the expired certificate from the trust store.

19. The method of claim 15, wherein STP certificates are automatically renewed based on the associated expiration date of the STP certificate and wherein the renewed one or more STP certificates are automatically copied to the server which has the STP certificate in use.

20. The method of claim 19, wherein the server restarts to activate the renewed one or more STP certificates, and wherein the restart is scheduled based on a manually selected time frame.
